(19) United States
(12) Patent Application Publication
(10) Pub. No.: US 2015/0012886 A1
(43) Pub. Date: Jan. 8, 2015

(54) METHOD, APPARATUS, AND COMPUTER-READABLE STORAGE MEDIUM FOR CHANGING AN ACCESS STATE OF A DEVICE BY PATTERN RECOGNITION

(71) Applicant: CISCO TECHNOLOGY, INC., San Jose, CA (US)

(72) Inventors: Hyman LU, Hefei (CN); Ruwei Liu, Hefei (CN); Hao Ling, Hefei (CN); Allen Jia, Hefei (CN)

(21) Appl. No.: 13/936,880

(22) Filed: Jul. 8, 2013

(51) Int. Cl. G06F 3/0482

(52) U.S. Cl. CPC G06F 3/0482
USPC 715/835

(57) ABSTRACT

In one embodiment, a method includes determining a first display position for each of a plurality of images and displaying the images at the corresponding first display position, receiving first plurality of taps, associating each of the first plurality of taps with a corresponding image, to produce a first tapping pattern, storing the first tapping pattern, which includes the first plurality of taps and the corresponding images in an associated relationship, determining a second display position for each of the images and displaying the images at the corresponding second display positions, receiving second plurality of taps, associating each of the second plurality of taps with a corresponding image, which are displayed at the second display positions, to produce a second tapping pattern, determining whether the second tapping pattern matches the first tapping pattern, and changing an access state of the electronic device in response to determining a match.

### BACKGROUND

1. Technical Field

The present disclosure relates generally to a method, apparatus, and computer-readable storage medium for changing an access state of an electronic device.

2. Background

Today, electronic devices may contain sensitive information therein and thus security to protect this information is often relied upon. A mobile or cellular telephone, for example, may automatically lock access to the device after a predetermined time that the device is idle. Once the screen has been locked, a user may gain access to the device by unlocking the device using, for example, a password.

However, passwords (typically a few digits in length) may be relatively easily compromised by another person who, for example, may see the password as the user is entering it into the device.

### BRIEF DESCRIPTION OF THE FIGURES

The disclosure will be better understood from reading the description which follows and from examining the accompanying figures. These figures are provided solely as non-limiting examples of the embodiments. In the drawings:

FIG. 1 illustrates a device upon which an embodiment of the present disclosure may be implemented;

FIGS. 2A and 2B show display areas for entering a tap pattern/melody;

FIGS. 3A and 3B show display areas, with sub-regions, for entering a tap pattern/melody;

FIGS. 4A and 4B show display areas for entering a tap pattern/melody onto shapes/patterns/images;

FIG. 5 is a flow chart illustrating a method for defining a tap pattern/melody;

FIG. 6 is a flow chart illustrating a method for unlocking an electronic device based on a tap pattern/melody; and

FIG. 7 illustrates a computer system (apparatus) upon which an embodiment of the present disclosure may be implemented.

### DESCRIPTION OF EXAMPLE EMBODIMENTS

### Overview

In one embodiment, a method includes determining a first display position for each of a plurality of images and displaying the plurality of images at the corresponding first display position on a display, receiving a first plurality of taps, associating each of the first plurality of taps with a corresponding image of the plurality of images, to produce a first tapping pattern, and storing the first tapping pattern, which includes the first plurality of taps and the corresponding images in an associated relationship. The method also includes determining a second display position for each of the plurality of images and displaying the plurality of images at the corresponding second display positions on the display, receiving a second plurality of taps, associating each of the second plurality of taps with a corresponding image of the plurality of images, which are displayed at the second display positions, to produce a second tapping pattern, determining whether the second tapping pattern matches the first tapping pattern, and changing an access state of the electronic device in response to determining that the second tapping pattern matches the first tapping pattern.

### DETAILED DESCRIPTION

As used herein the words “a,” “an,” and “the” and the like carry the meaning of “one or more.” An “apparatus” or “device,” as used herein, may refer to any type of electronic device that includes a display. One example of such a display is a touch-screen display. However, the present embodiments may also be applied to a display that is not a touch-screen display. Examples of electronic devices include, but are not limited to, a Personal Computer (PC), a video conferencing terminal, a mobile or cellular telephone, a tablet, an Automated Teller Machine (ATM), or the like.

As used herein, the term “passcode” may refer to any type of text, sequence of actions (including tapping on a touch-screen display), or a combination thereof, used to gain access to an electronic device.

As used herein, the terms “lock” and “locked” may refer to a state of the device in which only some of (for example, a subset of) the features of the particular device are accessible to a user. In one embodiment, such subset of features may only include the features required to present a lock/unlock option (screen) to the user. In one embodiment, such subset of features may include additional features of the electronic device.

As used herein, the terms “unlock” and “unlocked” may refer to a state of the device in which a majority of (or all of) the features of the particular device are accessible to a user. For example, once a mobile telephone is unlocked, the user may gain access to the information therein including, for example, contacts, electronic mail (email), and the like, as well as access to use the features of the device, such as, placing a call, using the web browser, using the camera, and the like.

A tapping pattern can be recognized as a series of inputs (taps) received in a time sequence (time period) on the electronic device. In particular, a tapping pattern may include the length of time (i.e., lasting time) an area of a screen of the electronic device is tapped/pressed (for example, a short tap versus a long tap) and the length of time (i.e., time spacing) between two of a plurality of taps. Note that in an embodiment, a short tap may be defined as a tap lasting under a predetermined period of time (for example, X), a medium tap may be defined as a tap lasting more than X but less than a second predetermined period of time (for example, Y), and a long tap may be defined as a tap lasting more than Y.

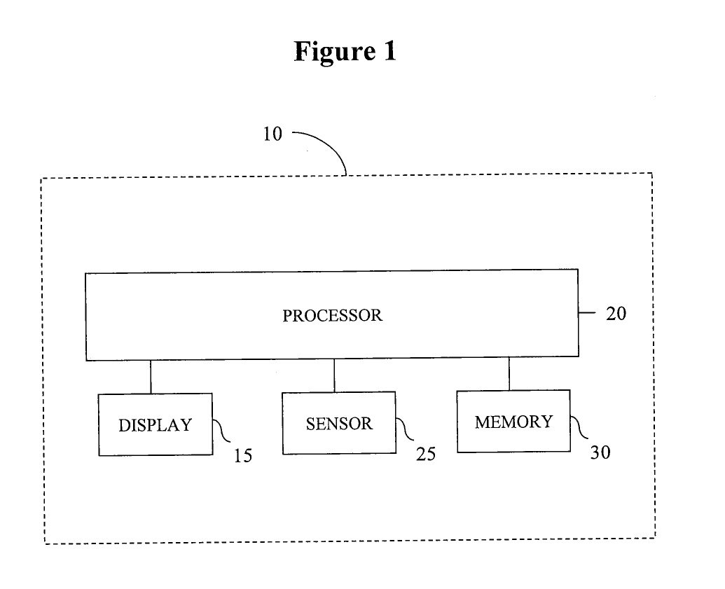

FIG. 1 shows various components of electronic device 10, which in an embodiment is a mobile telephone. Note that electronic device 10 shown in FIG. 1 may include additional components that are typically part of a mobile telephone. However, the aforementioned additional components are not shown in the figure. Electronic device 10 of FIG. 1 includes a processor 20, a display 15, a sensor 25, and memory 30.

Each of the functions of the described embodiments may be implemented by one or more processing circuits. A processing circuit includes a programmed processor (for example, processor 20), as a processor includes circuitry. A processing circuit also includes devices such as an application specific integrated circuit (ASIC) and conventional circuit components arranged to perform the recited functions.

A sensor (for example, sensor 25) within the device can be provided and accompanying software, firmware, and/or hardware is provided to monitor for and interpret such tap(s) (performed, for example, by the aforementioned processor 20) to evaluate whether a passcode (tapping pattern) is being tapped by the user into device, and whether the passcode is correct/matches a predefined passcode.

Once the device is locked, a user needs to unlock the device to use it and/or access information therein. The device is unlocked by triggering sensor(s) (for example, sensor 25) on the device in a way that matches the device's predetermined (or user input) unlocking pattern. The aforementioned sensor(s) may be, for example, an accelerometer or any other type of sensor or sensors capable of generating a tap signal when a tap is detected. The tap may be received via a touch screen. The accelerometer may be of any type including capacitive, piezoelectric, or piezoresistive.

In the device, a monitoring circuit, for example, monitors for a specific activation of a sensor or input device. When the sensor 25 is activated (for example, when a user touches a touch-screen display of the device), the sensor 25 generates a tap signal that is provided to an management processor or processing circuit (for example, processor 20). Note that for a device that includes a non-touch display, a “tap signal” may be generated based on user inputs via a keyboard and/or a pointing device, such as a mouse.

The management processor (processing circuit 20) evaluates the tap signal, and if the tap signal matches the predetermined unlocking signal, then the device is unlocked and thus additional access can be provided to other (or all) features of the device. Note that the monitoring circuit and the management processor may be the same processor/processing circuit 20 or may be different components.

When the device is in an unlocked state, the device may be placed into a locked state by entry of a specific locking command that is detected by the device, or after a predetermined amount of time that the device is idle (an amount of time that the user has not performed an operation on the device).

When the device is being used with full access to its functions (for example, in an unlocked state), the device can be locked by tapping a locking pattern on the device. With the tapping interface, locking or unlocking access to the device can be done quickly, such as while the device is being brought to or removed from the pocket of the user as the user holds it in hand. In addition, the device can provide a learning routine to allow the user to provide a tapping input (passcode) to define a locking or unlocking signal through a graphical user interface (GUI) on the touch-screen display of the device. Note that text passwords (which, in an embodiment, may accompany a tapping pattern) may also be input by the user via the GUI.

For the locking pattern, while any pattern can be used, it is preferably simple enough to be remembered, but complex enough to not be easily reproduced by an unauthorized user and to prevent false positive patterns. For example, a locking pattern may be as simple as two taps in a defined time period. While the locking pattern may be a single tap, a single tap may lead to false positives, such as an inadvertent nudge causing the device to be incorrectly locked. The locking pattern may or may not be identical to the unlocking pattern. For the unlocking pattern, an unlock tap pattern may be used as the access passcode, which may replace or augment a traditional text-type password.

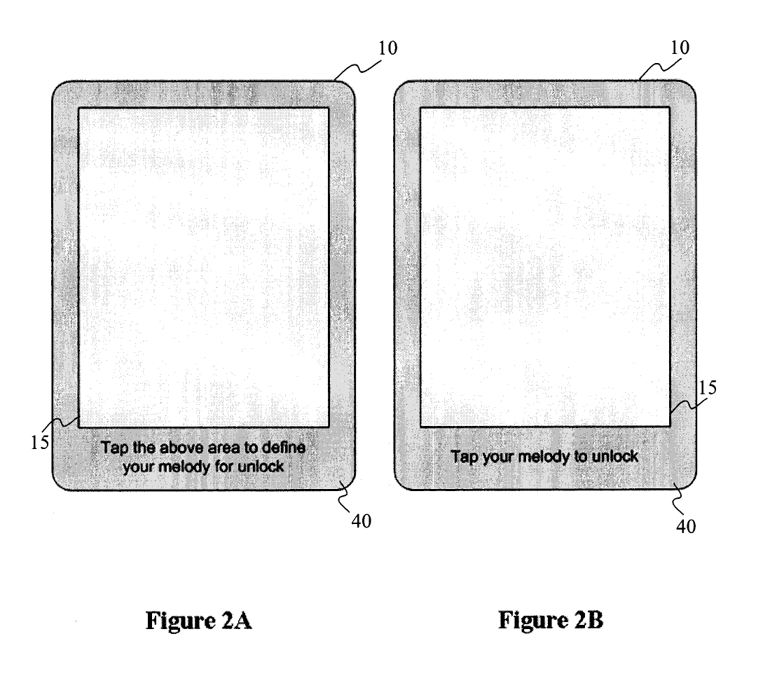

FIG. 2 illustrates electronic device 10 that includes a touch-screen display 15 with a GUI. As can be seen in FIG. 2A, an instruction 40 may be displayed to instruct the user to tap an area of the screen to input/create/define a passcode (in this case, a melody/tapping pattern) that will be used to unlock the electronic device 10. The melody may be any melody the user wishes to input and may have any number of taps. In one embodiment, the aforementioned melody may include a Morse-code type of taps that vary in length (for example, a short tap, a long tap, etc.). In one embodiment, the aforementioned melody may include, for example, a short tap, a medium tap, a long tap, etc.

As noted above, the taps are differentiated based on the time an area of a screen of the electronic device is tapped/pressed (for example, a short tap when screen is tapped for a short period of time versus a long tap when screen is tapped for a longer period of time) and the time between each of a plurality of taps.

With the configuration discussed with respect to FIG. 2, the user may tap anywhere in the designated area of screen 15 to define the melody. As such, once the melody has been defined by the user and stored by device 10, the user may unlock the device by tapping the defined melody anywhere on the designated area of screen 15, as shown in FIG. 2B. Note that in FIG. 2B, an instruction 40 may also be displayed to prompt the user to enter the melody to unlock the device. Note that in such embodiment, the user need not tap the same area of the screen 15 (FIG. 2B) when unlocking the device as was originally tapped when the melody was defined (FIG. 2A). However, the user needs to enter the same taps (with the same tempo or lasting time) in the same sequence and the same time between each tap to unlock device 10.

The lasting time and intervals between the input taps are recorded and quantified into discrete numbers by device 10 (in particular, by the combination of the sensor 25 and the processing circuit 20). Device 10 stores in memory (for example, memory 30 or other memory that is associated with or accessed by device 10) these input taps that define the melody/tapping pattern for unlocking device 10. In an embodiment, to improve accuracy, device 10 may instruct the user (for example, via an instruction 40) to input the melody multiple times to get the fault tolerance level of the input.

In a non-limiting example, the user may choose to define a melody by entering on the screen of FIG. 2A the following taps:
• • _ • • _{———}
   In other words, the user may enter onto the designated area of screen 15 a short tap, a short tap, a medium tap, a short tap, a short tap, and a long tap. However, any combination of taps (with any combination of varying lengths) may be entered onto the electronic device of the present disclosure.

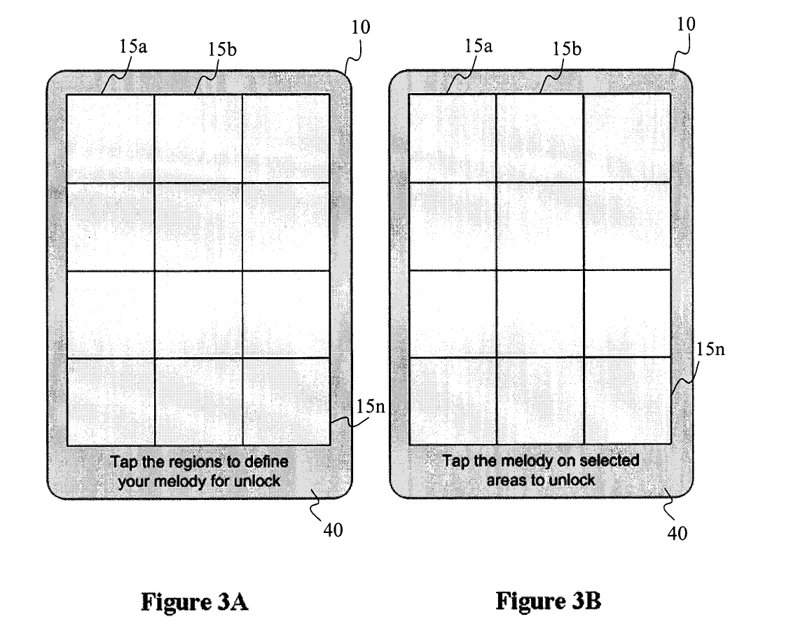

Next, as illustrated in FIG. 3, the designated area of screen 15 may be divided in various sub-regions 15a-15n. In one embodiment, each of the regions 15a-15n may provide a different sound/tone/melody when tapped by a user. For example, region 15a may produce a different sound/tone/melody when tapped than the sound/tone/melody produced when area 15b or area 15n is tapped. In one embodiment, however, all regions 15a-15n may have the same sound/tone/melody.

In FIG. 3, device 10 checks both for the tempo (for example, short tap, medium tap, long tap, etc.) of the tapping as well as the tapping region 15a-15n of the designated area of screen 15. This configuration provides an extra layer of security as both the tempo of the taps and the tapping regions on the screen 15 are taken into account when unlocking device 10.

In a non-limiting example, the user may choose to define a melody by entering on the screen of FIG. 3A the following taps:
• • _ • • _{———}
   In other words, the user may enter on the designated area of screen 15 a short tap, a short tap, a medium tap, a short tap, a short tap, and a long tap. Additionally, in a non-limiting example, the aforementioned taps may be entered, respectively, into the following regions of the designated area of screen 15:
15a, 15b, 15d, 15n, 15b, 15n.

Accordingly, when the unlocking screen is displayed in FIG. 3B prompting the user to enter the defined melody to unlock the device, the user would have to correctly enter the aforementioned taps in the same order and in the same areas as defined above. In other words, the user would have to enter the following on the designated area of screen 15:
• (in 15a) • (in 15b)_(in 15d) • (in 15n) • (in 15b)_{———}(in 15n).

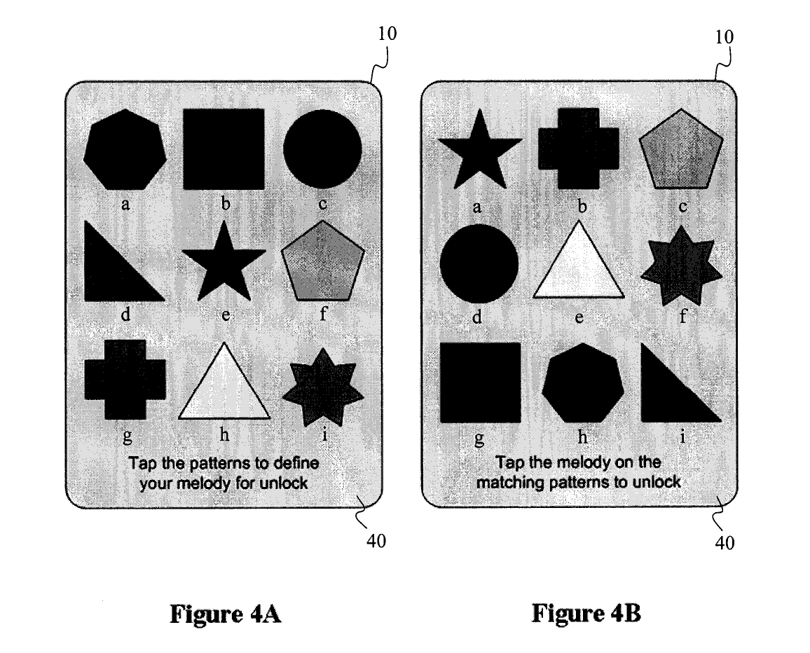

Next, as illustrated in FIG. 4, the designated area of screen 15 may include various patterns/shapes such as, but not limited to, a square, a star, a triangle, and the like. When the user defines a melody, as discussed above, he or she not only inputs a sequence of taps, but also inputs these taps onto specific shapes/patterns. In a non-limiting example, the user may choose to define a melody to be used as a passcode to unlock device 10 by entering the following taps:
• • _{—}
   In a non-limiting embodiment, these taps may respectively be entered by tapping the square, followed by the star, followed by the triangle (the middle column of FIG. 4A). In this embodiment, device 10 stores these input taps that define the melody for unlocking device 10 along with the corresponding tapped shape/pattern. Thus, following from the above example, device 10 stores the first short tap in an associated relationship with the square, the second short tap in an associated relationship with the star, and the medium tap in an associated relationship with the triangle.

As illustrated in FIG. 4B, device 10 presents a screen to prompt the user (via instruction 40) to enter the melody to unlock the device, and presents the shapes/patterns of FIG. 4A in a shuffled manner with respect to the pattern used to define the melody in FIG. 4A. However, such shuffling is only an example and is not required in all implementations.

In one embodiment, to unlock device 10, the user must enter the correct tapping sequence along with the sequence of first tapping the square, followed by the star, followed by the triangle. As can be seen from FIG. 4A, the square, star, and triangle were located down the center of designated area of screen 15, whereas in FIG. 4B, as a result of the shuffle, these shapes/patterns are located in different areas (i.e., the square is located at the bottom left, the star is located at top left corner, and the triangle is in the middle). Note that the aforementioned shapes/patterns may be randomly shuffled each time they are presented to the user, and thus, their locations will vary. Such shuffling provides enhanced security. For example, even if an unauthorized user learns the particular melody defined by the user, the unauthorized user may not gain access to device 10 if each of the taps comprised in the melody do not correspond to the particular shape/pattern.

Since the defined melody in the embodiment of FIG. 4 requires an input of a sequence of taps onto specific shapes/patterns and these shapes/patterns are shuffled and displayed in different regions of the designated area of screen 15 (compare FIGS. 4A and 4B), device 10 may keep track of the location of each of the shapes/patterns in the designated area of screen 15 every time these shapes/patterns are displayed (for example, both at the screen shown in FIG. 4A and at the screen shown in FIG. 4B). Device 10 may be programmed never to repeat the pattern of FIG. 4A after the melody is defined. Alternatively, the pattern may be shuffled without regard to any previous arrangement of the shapes/patterns.

In one embodiment, the processor 20 of device 10 may accomplish the aforementioned by associating each region of the screen 15 (for example, sub-regions 15a-15n, as discussed in FIG. 3) with a particular shape/pattern for each display view. This relationship may be stored in a memory of device 10. For the display of FIG. 4A, device 10 may store the following information:

| Pattern | Region |
|---|---|
| Heptagon (or Pattern #1) | 15a |
| Square (or Pattern #2) | 15b |
| Circle (or Pattern #3) | 15c |
| Triangle #1 (or Pattern #4) | 15d |
| Star #1 (or Pattern #5) | 15e |
| Pentagon (or Pattern #6) | 15f |
| Cross (or Pattern #7) | 15g |
| Triangle #2 (or Pattern #8) | 15h |
| Star #2 (or Pattern #9) | 15i |

For the display of FIG. 4B, the shapes/patterns are shuffled, and thus the device 10 may store the following information reflecting the new positions of the shapes/patterns:

| Pattern | Region |
|---|---|
| Heptagon (or Pattern #1) | 15h |
| Square (or Pattern #2) | 15g |
| Circle (or Pattern #3) | 15d |
| Triangle #1 (or Pattern #4) | 15i |
| Star #1 (or Pattern #5) | 15a |
| Pentagon (or Pattern #6) | 15c |
| Cross (or Pattern #7) | 15b |
| Triangle #2 (or Pattern #8) | 15e |
| Star #2 (or Pattern #9) | 15f |

In one embodiment, to save processing time, processor 20 may only store the position of the shapes/patterns selected by the user (i.e., in following from the above-discussed example, the position of the square, star (star #1), and triangle (triangle #2)). In other words, processor 20 may store in memory that the square is positioned at 15b, that star #1 is positioned at 15e, and that triangle #2 is positioned at 15h.

When it comes to shuffling the shapes/patterns, processor 20 may randomly shuffle the positions of the aforementioned three shapes/patterns, and position the remaining shapes/patterns in the remaining positions on screen 15.

Accordingly, based on this information, processor 20 of device 10 is able to determine what shape/pattern was tapped by the user when the melody (passcode) was initially defined, and determine if the same sequence/pattern is input by the user (when prompted, as shown in FIG. 4B) to determine whether a match exists. In one embodiment, device 10 is unlocked only when it is determined that a match between the two patterns exists.

In one embodiment, the user may customize the patterns shown in FIG. 4. For example, some or all of the patterns/shapes illustrated in FIG. 4 may be replaced with images stored in device 10. Such images may be images of the user's family, friends, interests, places visited, or the like. An advantage to replacing the shapes shown in FIG. 4 with the user's images is to increase the likelihood that the user will remember the particular sequence initially input to define the melody. Furthermore, as some shapes may appear similar, using the user's images may help the user better distinguish one image from another image.

If the user's images are used instead of the shapes shown in FIG. 4, the user no longer has to remember the above-discussed sequence as square, followed by star, followed by triangle, which may be difficult to remember because, there may be no particular relationship between these shapes to the user. However, the user may more easily remember the particular sequence if there is a relationship that is unique to the user.

For example, assume the various shapes illustrated in FIG. 4 are replaced with user's images stored in device 10, and the square is replaced by an image of the user (i.e., a first image), the star (star #1) is replaced by an image of the user's spouse (i.e., a second image), and the triangle (triangle #2) is replaced by an image of Paris (i.e., a third image). In such case, the user may more easily recall the particular sequence because there may be a particular relationship among the aforementioned images to the user. In other words, a relationship among the three aforementioned images may be that the user (depicted in the first image) and the user's spouse (depicted in the second image) spent their honeymoon in Paris (depicted in the third image). Thus, in keeping this relationship in mind, the user may more easily remember that the first tapped image is the image of the user, the second tapped image is the image of the user's spouse, and the third tapped image is the image of the place they spent their honeymoon.

The user may, of course, use such relationship between images when initially creating the pattern sequence. In other words, when creating the pattern sequence, the user may choose the aforementioned three images (as opposed to other displayed images) because these three images may be the only images for which the user can find a relationship, thereby making it easier to recall the pattern sequence at a later time.

Note that the aforementioned relationship between the images, which is unique to the user, may be stored by device 10 along with the defined melody and associated sequence of tapped images. As an added security feature, the device 10 may ask the user what the relationship is between the tapped images, after the tapping pattern has been entered by the user and after it has been determined that the entered tapping pattern matches the unlocking tapping pattern previously defined by the user and stored by device 10. Such inquiry may be displayed in section 40 of designated area of screen 15. The user may respond to the aforementioned inquiry by entering (i.e., typing) into the electronic device the particular relationship. In one embodiment, device 10 may be unlocked only after the aforementioned security question is correctly answered (and, as noted above, after the tapping pattern has been entered by the user and after it has been determined that the entered tapping pattern matches the unlocking tapping pattern previously defined by the user and stored by device 10).

Defining a melody and associating each tap with a particular shape/pattern/image, as discussed above with reference to FIG. 4, provides enhanced security. Thus, even if an unauthorized user learns the particular melody defined by the user, the unauthorized user may not gain access to device 10 if each of the taps comprised in the melody do not correspond to the particular shape/pattern/image. Furthermore, an unauthorized user may not gain access to the device if he or she does not correctly respond to the security question.

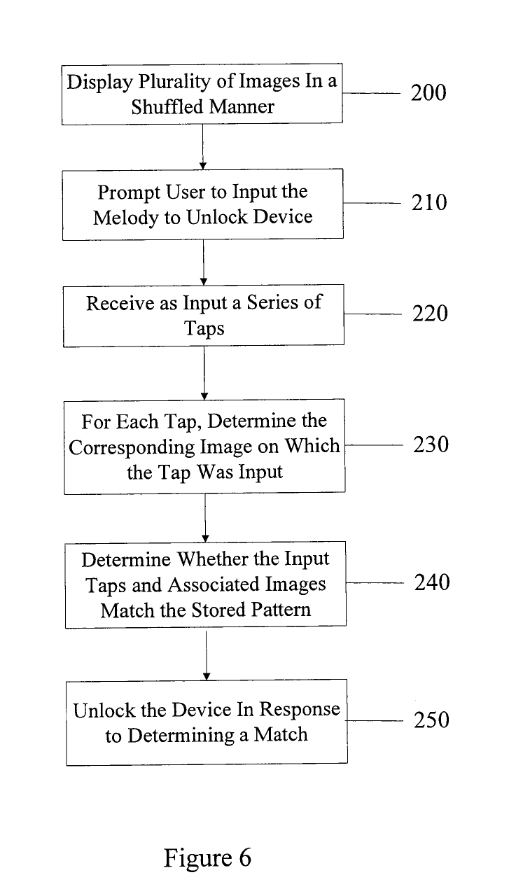

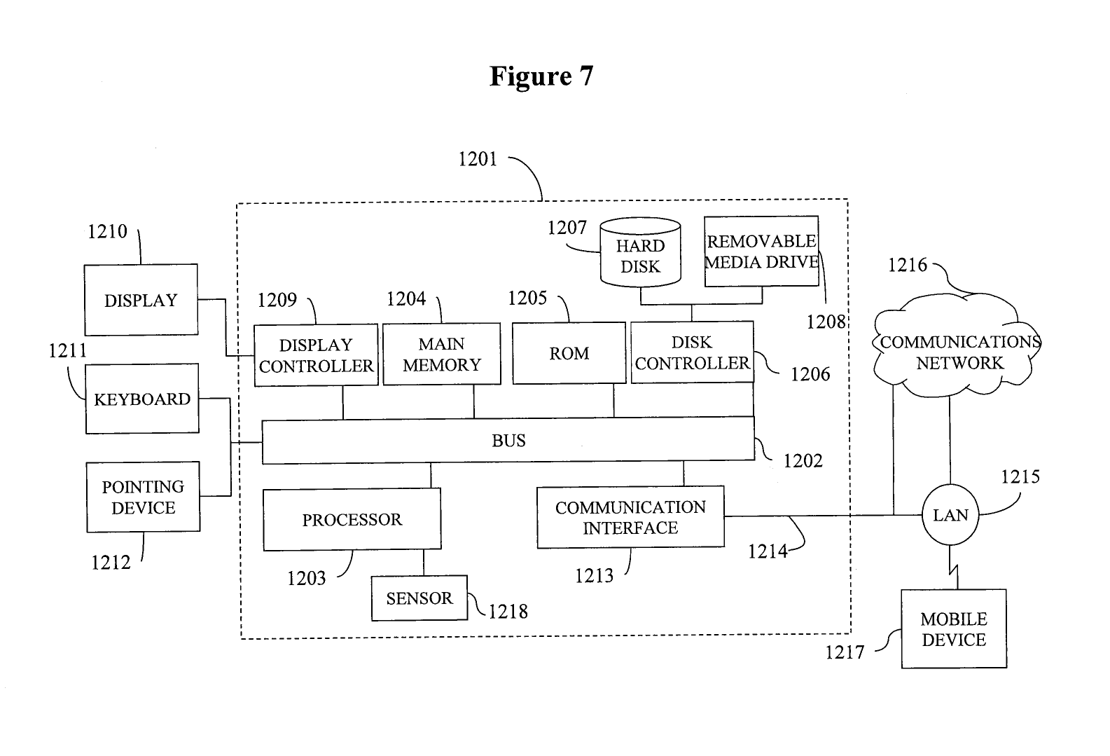

FIGS. 6 and 7 summarize the above-discussed methods of defining a tapping pattern (melody) for unlocking a device and for unlocking the device using such pattern. The processes of FIGS. 6 and 7 may be performed by processing circuit 20 and/or other components (shown, for example, in FIG. 1) of electronic device 10.

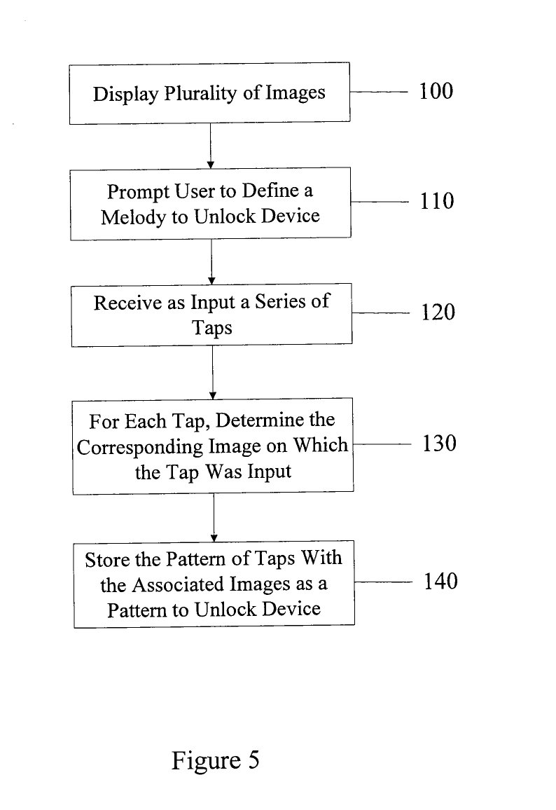

Turning to FIG. 5, in step 100, device 10 determines display positions of a plurality of images (such as the shapes/patterns shown in FIG. 4A), and displays these images at the determined positions on display 15 of device 10 (as shown in FIG. 4A). Next, in step 110, device 10 prompts the user (for example, via instruction 40 shown in FIG. 4A) to define a melody to unlock the device. In step 120, device 10 receives as input a series of taps, which have been entered by the user on display 15.

Next, in step 130, device 10 determines, for each input tap, the corresponding image on which the tap was input (i.e., the corresponding image tapped by the user when entering the melody). In following the example discussed above with reference to FIG. 4, device 10 determines that the user entered a first tap on the square, a second tap on star #2, and a third tap on triangle #2. In step 140, device 10 stores the aforementioned pattern of taps with the associated image (or shape/pattern) as the pattern to unlock the device.

FIG. 6 shows the process for unlocking the device using the aforementioned stored pattern defined in the process of FIG. 5. In step 200, device 10 determines shuffled display positions (as shown in FIG. 4B) of the plurality of images (such as the shapes/patterns shown in FIG. 4A), and displays these images at the determined shuffled positions on display 15 of device 10 (as shown in FIG. 4B). Next, in step 210, device 10 prompts the user (for example, via instruction 40 shown in FIG. 4B) to input a melody to unlock the device. In step 220, device 10 receives as input a series of taps, which have been entered by the user on display 15.

Next, in step 230, device 10 determines, for each input tap, the corresponding image on which the tap was input (i.e., the corresponding image tapped by the user when entering the melody). In step 240, device 10 determines whether the input tapping pattern (along with the associated images) match the stored pattern defined in FIG. 5.

In one embodiment, in order to determine whether the two patterns match, device 10 determines whether the lasting time of each of the input taps and the time spacing (or interval) between each of the taps match the lasting time and the time spacing of each of the stored taps, and determines whether each of the input taps are associated with the same image as each of the taps previously defined. However, in one embodiment, device 10 may determine whether the lasting time of each of the input taps match the lasting time of the stored taps and determine whether each of the input taps are associated with the same image as each of the stored taps, without taking into account the time spacing (or interval) between each of the taps. In other words, in such embodiment, two patterns may be considered a match regardless of whether the time spacing between each of the taps match.

In one embodiment, device 10 may determine whether the time spacing between each of the input taps match the time spacing of the stored taps and determine whether each of the input taps are associated with the same image as each of the stored taps, without taking into account the lasting time of each of the taps. In other words, in such embodiment, two patterns may be considered a match regardless of whether the lasting time of each of the taps match.

In step 250, an access state of device 10 is changed (for example, device 10 is unlocked) in response to a match having been determined between the stored tapping pattern in FIG. 5 and the input tapping pattern in FIG. 6.

As discussed above, electronic device 10 can be a computer system as illustrated in FIG. 7. Various components of the electronic device 10 described above can be implemented using the computer system or programmable logic. FIG. 7 illustrates a computer system 1201 upon which embodiments of the present disclosure may be implemented. The computer system 1201 may perform the above-described processes (for example, the processes discussed with respect to FIGS. 5 and 6). Note that various components of the system of FIG. 7 may be included in the electronic device 10 of FIG. 1.

The computer system 1201 includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210 (which may correspond to, for example, display 15 of FIG. 1) such as a liquid crystal display (LCD), for displaying information to a computer user. The computer system includes input devices, such as a keyboard 1211 and a pointing device 1212, for interacting with a computer user and providing information to the processor 1203 (or processing circuit). The pointing device 1212, for example, may be a mouse, a trackball, a finger for a touch screen sensor (for example, sensor 1218, which may correspond to, for example, sensor 25 of FIG. 1), or a pointing stick for communicating direction information and command selections to the processor 1203 and for controlling cursor movement on the display 1210.

The computer system 1201 performs a portion or all of the processing steps of the present disclosure in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the present disclosure and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes.

Stored on any one or on a combination of computer readable media, the present disclosure includes software for controlling the computer system 1201, for driving a device or devices for implementing the invention, and for enabling the computer system 1201 to interact with a human user. Such software may include, but is not limited to, device drivers, operating systems, and applications software. Such computer readable media further includes the computer program product of the present disclosure for performing all or a portion (if processing is distributed) of the processing performed in implementing the invention.

The computer code devices of the present embodiments may be any interpretable or executable code mechanism, including but not limited to scripts, interpretable programs, dynamic link libraries (DLLs), Java classes, and complete executable programs. Moreover, parts of the processing of the present embodiments may be distributed for better performance, reliability, and/or cost.

The term “non-transitory computer readable medium” as used herein refers to any non-transitory medium that participates in providing instructions to the processor 1203 for execution. A computer readable medium may take many forms, including but not limited to, non-volatile media or volatile media. Non-volatile media includes, for example, optical, magnetic disks, and magneto-optical disks, such as the hard disk 1207 or the removable media drive 1208. Volatile media includes dynamic memory, such as the main memory 1204. Transmission media, on the contrary, includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present disclosure remotely into a dynamic memory and send the instructions over a telephone line using a modem. A modem local to the computer system 1201 may receive the data on the telephone line and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an integrated services digital network (ISDN) card. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc.). The signals through the various networks and the signals on the network link 1214 and through the communication interface 1213, which carry the digital data to and from the computer system 1201 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

While certain embodiments have been described, these embodiments have been presented by way of example only, and are not intended to limit the scope of the inventions. Indeed the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

1. A method comprising:
determining a first display position for each of a plurality of images and displaying the plurality of images at the corresponding first display position on a display;
receiving a first plurality of taps;
associating each of the first plurality of taps with a corresponding image of the plurality of images, to produce a first tapping pattern;
storing the first tapping pattern, which includes the first plurality of taps and the corresponding images in an associated relationship;
determining a second display position for each of the plurality of images and displaying the plurality of images at the corresponding second display positions on the display;
receiving a second plurality of taps;
associating each of the second plurality of taps with a corresponding image of the plurality of images, which are displayed at the second display positions, to produce a second tapping pattern;
determining whether the second tapping pattern matches the first tapping pattern; and
changing an access state of the electronic device in response to determining that the second tapping pattern matches the first tapping pattern.

2. The method according to claim 1, wherein
the first plurality of taps includes taps of different lasting times and time spacings,
each lasting time of the different lasting times corresponds to a length of time of a tap, and
each time spacing of the time spacings corresponds to a length of time between two taps.

3. The method according to claim 2, wherein
the determining determines whether the second tapping pattern matches the first tapping pattern by
determining whether a lasting time of each tap and a time spacing between each of the first plurality of taps match a lasting time and a time spacing of each of the second plurality of taps, and
determining whether each of the second plurality of taps are associated with a same image as each of the first plurality of taps.

4. The method according to claim 1, wherein the changing changes the access state of the electronic device by changing the electronic device from a locked state to an unlocked state.

5. An apparatus comprising:
a display; and
a processing circuit configured to
determine a first display position for each of a plurality of images and display the plurality of images at the corresponding first display position on the display,
receive a first plurality of taps,
associate each of the first plurality of taps with a corresponding image of the plurality of images, to produce a first tapping pattern,
store the first tapping pattern, which includes the first plurality of taps and the corresponding images in an associated relationship,
determine a second display position for each of the plurality of images and display the plurality of images at the corresponding second display positions on the display,
receive a second plurality of taps,
associate each of the second plurality of taps with a corresponding image of the plurality of images, which are displayed at the second display positions, to produce a second tapping pattern,
determine whether the second tapping pattern matches the first tapping pattern, and
change an access state of the electronic device in response to determining that the second tapping pattern matches the first tapping pattern.

6. The apparatus according to claim 5, wherein the display is a touch-screen display.

7. The apparatus according to claim 5, wherein
the first plurality of taps includes taps of different lasting times and time spacings,
each lasting time of the different lasting times corresponds to a length of time of a tap, and
each time spacing of the time spacings corresponds to a length of time between two taps.

8. The apparatus according to claim 7, wherein
the processing circuit determines whether the second tapping pattern matches the first tapping pattern by
determining whether a lasting time of each tap and a time spacing between each of the first plurality of taps match a lasting time and a time spacing of each of the second plurality of taps, and
determining whether each of the second plurality of taps are associated with a same image as each of the first plurality of taps.

9. The apparatus according to claim 5, wherein the processing circuit changes the access state of the electronic device by changing the electronic device from a locked state to an unlocked state.

10. A non-transitory computer-readable storage medium including computer executable instructions, wherein the instructions, when executed by a computer, cause the computer to perform a method, the method comprising:
determining a first display position for each of a plurality of images and displaying the plurality of images at the corresponding first display position on a display;
receiving a first plurality of taps;
associating each of the first plurality of taps with a corresponding image of the plurality of images, to produce a first tapping pattern;
storing the first tapping pattern, which includes the first plurality of taps and the corresponding images in an associated relationship;
determining a second display position for each of the plurality of images and displaying the plurality of images at the corresponding second display positions on the display;
receiving a second plurality of taps;
associating each of the second plurality of taps with a corresponding image of the plurality of images, which are displayed at the second display positions, to produce a second tapping pattern;
determining whether the second tapping pattern matches the first tapping pattern; and
changing an access state of the electronic device in response to determining that the second tapping pattern matches the first tapping pattern.

11. The non-transitory computer-readable storage medium according to claim 10, wherein
the first plurality of taps includes taps of different lasting times and time spacings,
each lasting time of the different lasting times corresponds to a length of time of a tap, and
each time spacing of the time spacings corresponds to a length of time between two taps.

12. The non-transitory computer-readable storage medium according to claim 11, wherein
the determining determines whether the second tapping pattern matches the first tapping pattern by
determining whether a lasting time of each tap and a time spacing between each of the first plurality of taps match a lasting time and a time spacing of each of the second plurality of taps, and
determining whether each of the second plurality of taps are associated with a same image as each of the first plurality of taps.

13. The non-transitory computer-readable storage medium according to claim 11, wherein the changing changes the access state of the electronic device by changing the electronic device from a locked state to an unlocked state.
